(19) United States
(12) Patent Application Publication
(10) Pub. No.: US 2021/0117172 A1
(43) Pub. Date: Apr. 22, 2021

(54) DATA-DRIVEN CONSUMER JOURNEY OPTIMZATION SYSTEM FOR ADAPTIVE CONSUMER APPLICATIONS

(71) Applicant: PCCW VUCLIP (SINGAPORE) PTE. LTD., SINGAPORE (SG)

(72) Inventors: Satheesh Kumar Madathiparambil Gopinathan Nair, Mountain House, CA (US); Vaibhavi Hemant Gondil, Maharashtra (IN); Koushik Vasant Kulkarni, Maharashtra (IN); Tushar Harduley, Maharashtra (IN)

(21) Appl. No.: 16/658,580

(22) Filed: Oct. 21, 2019

(51) Int. Cl. G06F 8/60; G06F 8/71; G06F 8/77; G06F 11/34; G06F 11/30; G06N 20/00; G06N 5/04

(52) U.S. Cl. CPC G06F 8/60; G06F 8/71; G06F 8/77; G06N 5/04; G06F 11/302; G06N 20/00; G06F 11/3409

(57) ABSTRACT

A feature optimization system enables customizations of features, journeys, and flows in a consumer application. Configuration of a feature is conceptualized as an experimental rollout, or release, to a targeted segment of users. Distribution of the feature is optimized based on performance data and metric data associated with a performance indicator.

### TECHNICAL FIELD

Embodiments relate generally to software application delivery, and, more specifically, to techniques for data-driven consumer journey optimization.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Online content distributors use a variety of consumer software applications to deliver features and flows to consumers. For example, content items may be published that range from amateur, user-uploaded video clips to high-quality television shows and movies. Other applications may include other features and flows that enable communication among consumers. A content distributor publishes a content item by making the content item available electronically to client computing devices through one or more access mechanisms known as channels or sites. Such sites may include different web sites, web applications, mobile or desktop applications, online streaming channels, and so forth. A site may be hosted by the content distributor itself, or by another entity, such as an Internet Service Provider or web portal. A site may freely publish and release features to enable consumption of a content item to all client devices, or impose various access restrictions on the content item, such as requiring that the client device present credentials associated with a valid subscription that permits access to the content item, or requiring that the client device be accessing the site through a certain provider or within a certain geographic area. Additionally, different geographic areas and regions may have different functional requirements of the software applications that distribute content. For example, a particular geographic region may not have access to the latest computing devices such that less features and flows need to be delivered to the software application operating on older computing devices.

Generally, the publishing of features and flows involves various steps in application deployment, such as sending one or more client devices a “link” that indicates a location from which such configuration data may be requested over a computer network. Moreover, publication may also require preliminary steps such as identifying where within the site a feature should be published and in what manner the publication should occur. For instance, a web site may include a number of different pages targeted to different audiences and purposes. Publication may require determining on which pages to publish the feature, as well as in which specific places and in which specific forms (e.g. links, menus, embedded videos, etc.) the feature should be published within the determined page(s).

Existing systems release new features and flows as part of different versions of a software application. However, because different geographic regions and areas may lack the technology to execute new features and flows, a need arises to manage different versions of the configured application. Additionally, existing systems lack methods and techniques to optimize feature deployment based on performance indicators.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B are illustrative views of high-level functional blocks of an example system in which the techniques described herein may be practiced;

FIG. 2 is an illustrative view of a network diagram, including an example feature optimization system;

FIG. 3 illustrates an example interaction diagram for optimizing features delivered in a software application;

FIG. 4 illustrates an example flow for optimizing features deployed to a percentage of targeted segments; and

FIG. 5 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

1.0. General Overview

2.0. Structural Overview

3.0. Functional Overview

4.0. Implementation Mechanism—Hardware Overview

5.0. Extensions and Alternatives

### 1.0. General Overview

Approaches, techniques, and mechanisms are disclosed for a feature optimization system through which different configurations may be packaged and published in a single application, enabling different segments of users to interact with different features and flows using the same application. According to one embodiment, a segment of users is defined based on one or more attributes shared by users, such as user demographics including geographic country and region, gender, and age group, user preferences including language preference, user behavior associated with functionalities, usage during a particular time of the day, personas, and so forth. A defined segment may be associated with an experimental rollout for deployment of a particular feature, or release, where a percentage of the defined segment receives the new feature upon launch of the application. Based on performance data captured at user devices by the application, key performance indicators (KPIs) may be determined. For example, if a business analyst desires to increase monetization of the application, a KPI may be a selected percentage increase in new subscriptions based on the deployment of a premium feature.

In an embodiment, some or all of the above deployment processes are facilitated by use of a construct referred to herein as a configuration placeholder. For example, a configuration placeholder may be an empty JSON which can contain as many configurations as required. An administrator user may generate a configuration placeholder and associate the configuration placeholder with a feature identifier. The placeholder carries with it some or all of the template data and layout data. In an embodiment, different types of placeholders have different template data and/or layout data, such that simply by creating a placeholder of a certain type and associating that placeholder with a feature identifier, an administrator user is assigning the template data and layout data associated with that type to the placeholder. For example, a feature or flow may have multiple alternatives, or versions. A placeholder for the feature may include template data information that includes user interface elements that enable a viewing user of the feature or flow to interact with and choose between the different alternatives, or versions, of the feature. A feature optimization system may rely on placeholders that can be configured to release the feature to the application.

A feature performance optimizer mechanism may use tracked user behavior associated with a deployed feature in an experimental rollout to optimize the feature rollout to the associated segment of consumers based on associated performance indicators. In this way, the feature optimization system may automatically increase or decrease the percentage of the segment that has received the feature associated with the experiment. In one embodiment, the optimization of feature deployment may occur in real-time, such that increased or decreased deployment and propagation of features occurs within minutes in the defined segment. A predictive feature selector mechanism may use machine learning and other artificial intelligence techniques to create or predict new experiments on segments of consumers that may be successful based on similar consumer segments in a different region.

In this way, the consumer journey, or a series of activities that a consumer performs in order to derive value from the application, or the transition of a consumer from one business state to another, is optimized and managed by the feature optimization system. For example, a new user to an application may be configured with a standard assortment of features based on the demographic data of the user (e.g., geographic country or region). As the user consumes various features of the applications, the feature optimization system may start to include the user in one or more defined segments (e.g., primary usage during 5-7 pm in the time zone of the user, other user demographics, other user behavior attributes). As a result, the user may receive different features based on KPIs associated with the features.

In other aspects, the invention encompasses computer apparatuses and computer-readable media configured to carry out the foregoing techniques.

### 2.0. Structural Overview

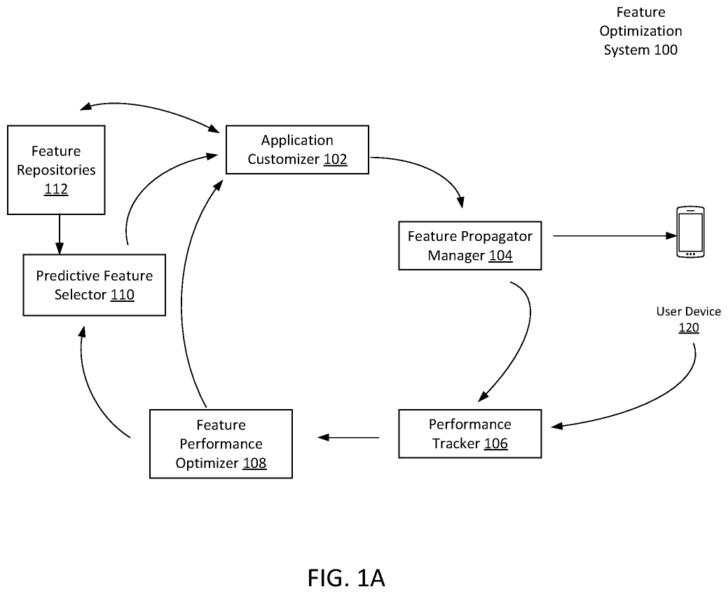

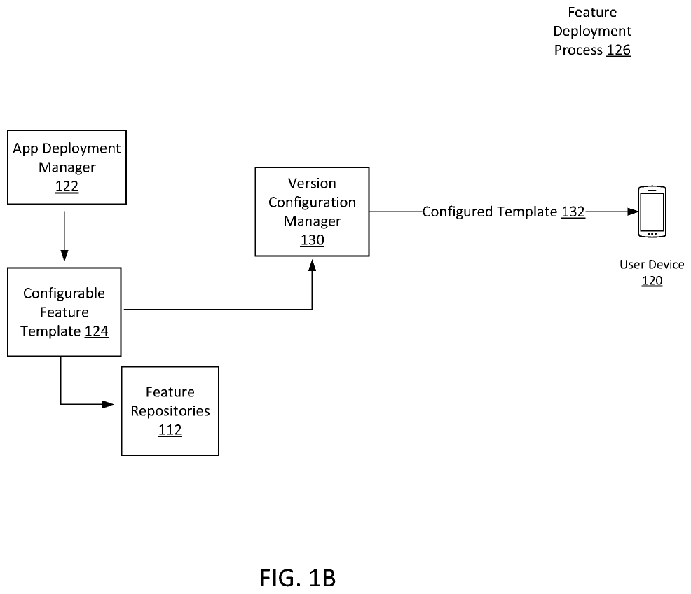

FIG. 1A is an illustrative view of high-level functional blocks of an example system in which the techniques described herein may be practiced. Feature optimization system 100 comprises an application customizer 102, a feature propagator manager 104, a performance tracker 106, a feature performance optimizer 108, a predictive feature selector 110, and feature repositories 112. A particular user device 120 may be configured with a set of default features. A user device may comprise any combination of hardware and software configured to implement the various logical components described herein. For example, the one or more user devices may include one or more memories storing instructions for implementing the various components described herein, one or more hardware processors configured to execute the instructions stored in the one or more memories, and various data repositories in the one or more memories for storing data structures utilized and manipulated by the various components.

System 100 facilitates the optimization of feature deployment across different instances of applications operating on user devices 120 across different geographic regions and different hardware platforms. An application customizer 102 provides a user interface for an administrator user to manually select a customization of an application to include or configure a feature to be rolled out to a defined segment of consumers. A feature propagator manager 104 manages the process of propagating features to user devices 120. The customizable application is capable of publishing externally customizable features and flows each time a new version is deployed. The customizable application is further capable of honoring consumer specific customization at run time. Each consumer event, such as page view, click, purchase, and so forth is logged at the user device 120 and captured by a performance tracker 106. An insights system, such as a feature performance optimizer 108, is capable of ingesting event logs and maintaining a global consumer view, or user profiles, that includes all available information about consumers, such as personal information, demographics, preferences, behavioral information, and so forth.

A consumer segmentation system is included in the feature optimization system 100 that includes the ability to create consumer segments based on one or more of the attributes available in the global consumer view, or user profile. A user interface for the application customer 102 enables product users to create consumer segments, customizations to application features and/or flows, associate a consumer segment to a customization, and associating certain key performance indicator (KPI) targets with a current experiment (or release), such as reach, engagement, monetization, and so forth. Rollout may be controlled by the feature propagator manager 104 where the current experiment is rolled out to a certain percentage of the target segment in order to identify the production impact of a customization. A KPI tracking system, such as performance tracker 106, tracks target KPIs for every experiment.

A feedback loop is generated where the KPI tracking system, or performance tracker 106, uses statistical methods, machine learning and/or other artificial intelligence techniques to intelligently gauge whether an experiment is “successful” or “unsuccessful” and can further increase or decrease the rollout of the experiment to the target consumer segment to maintain the KPIs. A recommendation system, such as the predictive feature selector 110, tracks KPIs, segments, customizations, experiments, and other data to recommend segments and customizations to previously untargeted consumers. Feature repositories 112 include data associated with features and/or flows for selection and incorporation into an experimental rollout.

FIG. 1B is an illustrative view of high-level functional blocks of an example system in which the techniques described herein may be practiced. An app deployment manager 122 is a process that manages the deployment of an application. The application may be deployed through a backend process or from a client side process. A configurable feature template 124 describes the features that are configurable. For example, the template 124 may include 10 features that may be configurable for a user device 120. The configurable feature template 124 may be stored in feature repositories 112, in an embodiment. A version configuration manager 130 may receive a configurable feature template 124 and make configurations based on one or more attributes, such as operating system used on the user device 120, country specific features based on the country in which the user device 120 operates, and so forth. The configured template 132 is then sent to the user device 120 by the version configuration manager 130. As new features get deployed, and added to the configurable feature template 124, the feature deployment process 126 described above may be used to push new features to a user device 120.

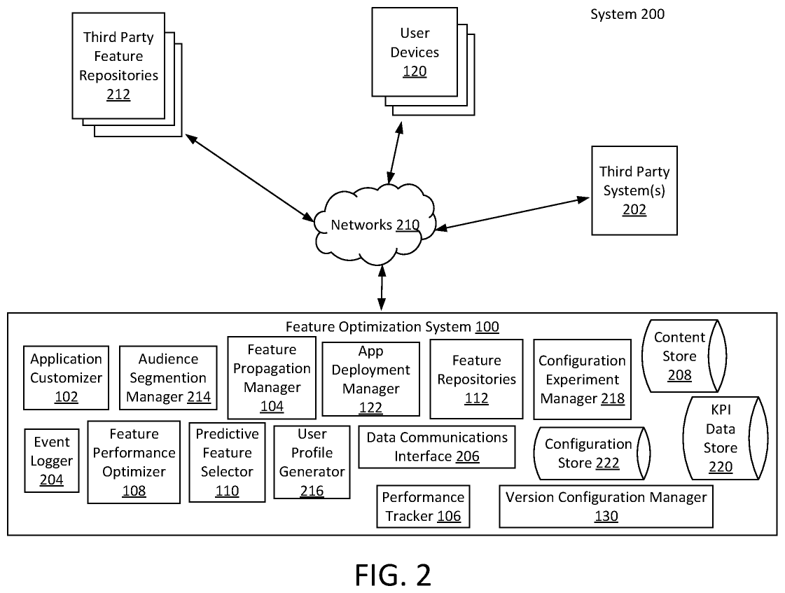

FIG. 2 is an illustrative view of various aspects of an example feature optimization system 100, according to an embodiment. System 100 comprises one or more computing devices. These one or more computing devices comprise any combination of hardware and software configured to implement the various logical components described herein, including components 202-222. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components. As an example, queuing systems, such as Kafka and Google PubSub, may be used as part of system 100.

System 200 includes an example of feature optimization system 100 as illustrated in FIG. 1A. Other feature optimization systems 100 may have fewer or additional elements in varying arrangements.

FIG. 2 illustrates a high-level block diagram, including an example feature optimization system 100, according to an embodiment. A feature optimization system 100 may include an application customizer 102, a feature propagation manager 104, a performance tracker 106, a feature performance optimizer 108, a predictive feature selector 110, feature repositories 112, an app deployment manager 122, a version configuration manager 130, an event logger 204, a data communications interface 206, a content store 208, an audience segmentation manager 214, a user profile generator 216, a configuration experiment manager 218, a KPI data store 220, and a configuration store 222, in one embodiment. The feature optimization system 100 may communicate data over one or more networks 210 with other elements of system 200, such as user devices 120, one or more third party feature repositories 212, and one or more third party systems 202.

An application customizer 102 enables administrator users and/or other product users to select a feature to include in an experiment for rollout to a defined segment of consumers. The application customizer 102 operates on a super-set of customizable elements—features or flows. An adaptive application publishes the super-set of customizable elements every time a new version of the application and/or service is deployed. If an application consists of multiple services, each of these services may publish separate sets of customizable elements. In some embodiments, customizable elements may span several services. For example, a customizable flow may span several services, such as a subscription flow for an application user may span a consumer facing application, the backend application, and a billing service. In other cases, multiple microservices may support a single feature (e.g., a recommendations service and home page service both honoring content filters based on predefined criteria may represent a single feature). The services in an adaptive application define namespaces to separate customizable elements that are published.

Each customizable feature published by the adaptive application becomes a template for customization and comprises a feature identifier, a namespace, and a set of attributes including a name, type, valid values or ranges, mandatory or optional indicator, and so forth. Each customizable flow published by the adaptive application becomes a template from customization and comprises a flow state identifier, a namespace, an event identifier, a target state identifier, a target namespace identifier, and a set of attributes including a name, type, valid values or ranges, a mandatory or optional indicator, and so forth. Each state in a flow includes identifying information as well as exit transitions and any configurable attributes.

For products with applications on multiple platforms (e.g., Android/IOS Application as well as a mobile browser user experience), business users may desire uniform behavior across platforms. In some cases, business users may require application-specific behavior, meaning that certain features or flows exist based on the platform. The application customizer 102 supports both variants by including the following: (1) application agnostic abstracted states, (2) published common abstract states, (3) every adaptive application in a suite of related adaptive applications publishes a set of common states and a set of app-specific states, (4) a set of common transition events and a set of app-specific transition events are published for every adaptive application in a suite of related adaptive applications and (5) an administrator user of the feature optimization system 100 can choose a single application where the behavior needs configuring using a user interface via the application customizer 102.

A user profile generator 216 creates a system of record that includes all consumer attributes collated in one place. Attributes include demographic details, marketing campaigns, subscription status, etc. as well as derived attributes such as churn propensity, favorite content genre at various times of day for consumption, etc. for a video streaming application. A user profile is generated by the user profile generator 216 to create a “consumer one view” for each user using application logs and any other information available about the user. Application maintain consistent user identity across various application events as well as across various platforms—this user identity stitches together the information from application logs to build user attributes.

Application events are ingested in a queuing system and are grouped for each user using the uniform user identity. This is performed using a parallel processing engine (e.g., Apache Beam or Spark) in order to handle large numbers of active users on the end user facing applications. A single user may perform various activities within a few minutes and these activities may contribute to the user profile, meaning that the feature optimization system 100 operates in near real time. A micro batch based design may also work by splitting the user event stream into smaller batches. Apache Beam provides effective windowing and/or triggering mechanisms to achieve the micro batch based design. Attributes that can be captured at user level include user demographics (e.g., country/region, gender, age group), user preferences (e.g., language preference, most visited functionalities in the application based on the time of day, personas, etc.), acquisition/re-engagement parameters (e.g., whether a user is included in an acquisition or re-engagement campaign, offers and/or promotions, etc.), and predictive parameters (e.g., churn/subscription propensity, next watched genre (for video streaming applications), computed lifetime value, etc.

The process of user profile generation is configurable within the user profile generator 216 to enable tracking of new parameters periodically as business users generate new parameter requirements. A strategy pattern based process handles this by tracking parameters with strategies such as first, latest, accumulating, and average. The resulting user attributes can be stored in a NoSQL KV store such as Google DataStore or BigTable as these allow updates to individual properties and indexing that helps while retrieving the user data based on a property. The latest consumer attributes are maintained in a snapshot table, in an embodiment. Churned out users that are no longer active or inactive for a defined amount of time can be removed from the snapshot. This enables one-time segmentation on these users later in the pipeline. The consumer view process also requires a stream of user properties to be discoverable in order for further downstream systems to determine consumer segmentation in near real time.

An audience segmentation manager 214 enables an administrator user or other product users to define user segments and experiments within a user interface. Customization points from adaptive applications to create experiments are needed as well as consumer attributes to create the user segments. To enable segmentation, consumer attributes and operators on the attributes are used as filters. Additionally, allowed values may be defined, in an embodiment. For example, a “country” segment filter may include operators such as “equal,” “not equal,” “like,” and “not like” for this “country” attribute, and allowed values may include “India,” “Malaysia,” “Indonesia,” etc. The snapshots from the consumer view system may be the best sources of data for the audience segmentation manager 214 to cross reference segment definition to the same snapshot. Alternatively, this data may be generated by other consumer dimension processes, such as third party systems 202.

A user interface may be provisioned to enable power users, or administrator users, to create segments through the audience segmentation manager 214. The user interface consumes the list of available attributes, allowed operators, and allowed values through an application programming interface (API), in an embodiment. Serverless technologies (i.e., cloud computing services such as Google Cloud or AWS Lambda) may be used to create the API. Alternatively, APIs may be virtual machine/Kubernetes (an open source system for automating deployment, scaling, and management of containerized applications) based. Through the user interface, power users select attributes, the corresponding operator, and possible values to create the segment definition. The audience segmentation manager 214 stores all segment definitions in the feature optimization system 100 in a content store 208, in an embodiment. Consumers may be “tagged” with custom segments that are created based on various consumer attributes. For each new segment definition, a one-time segmentation may occur for all existing users using the latest consumer snapshot and the new segment definition, in an embodiment.

The application customizer 102 records the elements published by customizable applications such that the elements become available for configuration by an administrator user. Each customization is associated with a target consumer segment. This association is referred to as an experiment, in an embodiment. Each experiment is relatively ranked against other experiments such that the application customizer 102 may prioritize which customization to apply in the event of conflicting experiments at the same customization point. The application customizer 102 enables a user to choose one or more applications on which to configure behavior using “namespaces.” If a user attempts to configure uniform behavior across two namespaces, the states and event transitions that are common across the two namespaces will appear as configurable using the user interface provided by the application customizer 102.

Because a user's activity on the application will change its attributes and therefore the applicable segments, all segments are re-evaluated in near real time for each user. The audience segmentation manager 214 consumes the user data stream from the consumer one view and evaluates all active segments for each user. Users moving out of any segment due to a change in their properties are identified and removed from segments by the audience segmentation manager 214, in an embodiment. User segmentation details are communicated to downstream components as a map. For example, a map may be expressed as {“user_id”:“user_id_1”, “segments”: [{“name”:“s1”, “isInSegment”:True}, {“name”:“s2”, “isInSegment”:False}]

A feature propagation manager 104 publishes an experiment to be rolled out to a target percentage of consumers defined for the experiment. The experiment definition and the segment definition are sent to the audience segmentation manager 214 via a queuing system such as Pubsub or Kafka. The feature propagation manager 104 serves a configuration of the application for a given consumer when the application or service requests it. The feature propagation manager 104 may receive a request for application configuration in different manners. For example, a request may be received for one customization at the time of encountering the customization (high flexibility), a group of customizations (medium flexibility), or for all customizations at the time of start-up of the application (least flexibility because the configuration for all customizations will be fixed at the beginning). Upon receiving the request, the feature propagation manager 104 fetches the applicable segments for the user and the active experiments on these segments. Then, a consolidated configuration for the customizations is created based on the fetched experiments.

Experiments may be rolled out statically or dynamically and to a limited percentage of the consumer segment by the feature propagation manager 104. For example, an experiment may be rolled out to a small percentage of consumers, and if the KPIs indicate positive improvements, meaning that thresholds for positive behavior based on the KPIs are met or exceeded, then the rollout can be increased until the entire consumer base for a target consumer segment is covered. For a static daily consumer base, a static rollout is more efficient because it reduces the amount of processing during runtime. For a consumer application with a widely varying daily consumer base, a dynamic rollout is more relevant. The added runtime processing is a tradeoff for a more accurate rollout coverage.

In the event of experiment conflicts, where a consumer is included in more than one consumer segment and conflicting behavior is configured for each of these segments, experiment priority is used to resolve which customization to apply to the user. Experiment priority is set by the product or business administrator user in the feature optimization system 100. No two experiments can have the same priority. A forced prioritization is applied across multiple experiments to avoid ambiguity. In a conflict situation, if the higher priority experiment is already rolled out to a target percentage of consumers within the current time window, the experiment that is next in priority may be applied to the consumer. The feature propagation manager 104 moves down the list of applicable experiments in order of priority, assigning to the consumer the first experiment that has not achieved targeted rollout, in an embodiment. Once a customization has been applied to a consumer, it is made sticky for a pre-configured time period. Each customization may have different stickiness time periods. This prevents an inconsistent consumer experience within the application.

The consolidated configuration is sent as a response to the application requesting the configuration for the consuming user. As traffic becomes high on this service, a microservice based architecture along with a scalable platform like Kubernetes or Docker can be used for configuration management and deployment by the feature propagation manager 104. In addition to a pull-based configuration, an adaptive application may also subscribe for push-based configuration. For example, a new customization pushed to an application based on the user belonging to a user segment. The application would need a registered listener to process these events and honor the customization, in an embodiment.

A performance tracker 106 records events emitted by the application as the customized behavior is performed. This enables traceability of the performed customized behavior on the application. These events are used by the feature optimization system 100 to track whether the customized behavior led to improved KPIs. For example, if a new feature or flow involves a user clicking on a new button to activate a content stream on the application, the user clicking on the new button is an event that is tracked and captured by the performance tracker 106. Further, if the KPI associated with the new button is whether the user increases engagement with the application by more usage (more application opens) or more minutes viewing content, then the data captured by the performance tracker 106 includes this information. This type of information measures the effectiveness of the experiment. Other examples of KPIs that are defined before or at the time of customization includes conversion rate—the number of users subscribed/number of users eligible for subscription and engagement—the video minutes or video views or active users.

Application events are ingested by an event logger 204 to create a consumer one view, as described above as a user profile. The same application logs generated by the event logger 204 are aggregated based on the configuration context. The data integration may be done using an ETL manner by using Apache Beam/Spark or in an ELT manner by loading the events in a Massively Parallel Processing (MPP) datastore such as BIGQUERY and then aggregating using SQL. Primarily, two kinds of measurements are generated: 1) for a segment, KPI with customization against KPI without customization 2) for a customization, KPI for each applicable segment for the same customization. The resulting measurements are stored in a KPI data store 220. A configuration experiment manager 218 enables the KPI measurements to be accessed by a visualization tool such as TABLEAU or QLIKVIEW for ease of viewing. Administrator users can learn the business impact from the KPIs and decide to increase or decrease the rollout of the configuration and/or implement the experiment across other segments or remove the experiment altogether, in an embodiment. Through a feature performance optimizer 108, the feature performance may be optimized by increasing or decreasing the rollout of the experiment. In other embodiments, machine learning and/or artificial intelligence techniques may be used to automate the increase or decrease of the rollout of the configuration based on the KPIs meeting preset thresholds. The thresholds for KPIs may be defined at a default segment level (for each country) or specifically for a behavioral segment. The thresholds may also be dynamically defined based on a machine learning and/or artificial intelligence techniques, in an embodiment.

Defined KPIs may be monitored for each segment and the effect of each customization may also be monitored for a large time interval (e.g., 30 minutes or 1 hour) by the feature performance optimizer 108. The objective here is to optimize for a specific KPI or a balance of multiple KPIs. Based on this objective, the feature performance optimizer 108 generates an increase, decrease, or hold directive for each customization or segment. Open source metric optimization engines may be employed for this purpose. For each message requiring rollout increase or decrease, experiment messages with a step reduction or increase are triggered and sent to the web user interface system, which in turn would reduce or increase the effective rollout in the configuration delivery system, the feature propagation manager 104. The step size is configurable and relative to the monitoring interval of the monitoring process.

A predictive feature selector 110 provides recommendations for feature experiments to be deployed across other segments based on successful experiments on segments. A recommendation engine uses KPI level data from the KPI measurement system, the performance tracker 106. Segments where business critical KPIs are not optimized may be identified. Customizations that have been shown historically to improve such KPIs are then recommended for these segments.

For a given customization, the recommendation engine examines various segments where this customization is performing well to identify common segmentation criteria. Other segments that share some or all of this common segmentation criteria are then identified. If a target KPI for these new segments is the same or similar to what the customization is helping to improve, the customization may be recommended for these new segments.

Activity of users to whom customizations have been applied are monitored and criteria are identified to determine which users are affected or not affected by the customizations. These criteria may then be used as additional segmentation criteria. Unsupervised learning algorithms like clustering can be used to automatically identify such sub-segments. The recommendations may be displayed in the same user interface provided to power users or administrator users where customizations and/or segments are defined, as provided by the application customizer 102.

Feature repositories 112 include a listing of the customizable elements published by the adaptive application, in an embodiment. Feature repositories 112 may include a feature or a flow of features, in an embodiment. A data communications interface 206 enables data communication to flow from the feature optimization system 100 through one or more networks 210 to third party feature repositories 212, user devices 120, and/or third-party systems 202. A data communications interface 206 may comprise a web server, a microservice architecture, an application programming interface, or any other communications systems. Third party feature repositories 212 may include configurable feature templates to be sent to a version configuration manager 130, in an embodiment. In this way, an app deployment manager 122 may include new features and flows from third-party feature repositories 212 without incorporating those third-party feature repositories within the feature repositories 112. Similar to the feature deployment process depicted in FIG. 1B, the third party configurable feature template would be configured by the version configuration manager 130.

A content store 208 includes data representing content in the feature optimization system 100. Content may include user segments, for example. A configuration store 222 includes the active and inactive experiments of customizations, in an embodiment.

System 200 illustrates only one of many possible arrangements of components configured to provide the functionality described herein. Other arrangements may include fewer, additional, or different components, and the division of work between the components may vary depending on the arrangement. For example, in some embodiments, elements may be omitted, along with any other components relied upon exclusively by the omitted component(s). Although certain numbers of elements are depicted in FIG. 1 and FIG. 2, it will be apparent that system 200 may be utilized to publish any number of features to any number of user devices 120 using any number of feature optimization systems 100.

### 3.0. Functional Overview

In an embodiment, among other aspects, conceptualizing consumer facing applications as a set of configurable features, journeys, or flows and creating an optimization system is greatly simplified using application configuration deployment and programming techniques, such as described herein.

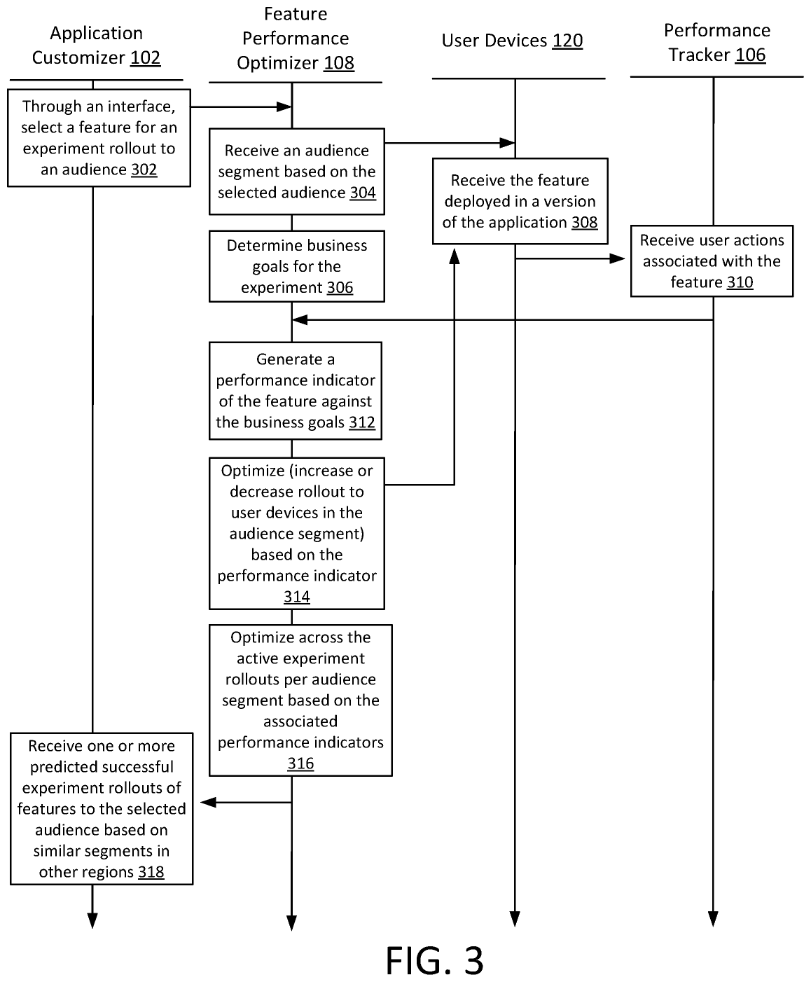

FIG. 3 illustrates an example interaction diagram for optimizing features delivered in a software application, according to an embodiment. The various elements of the interaction diagram illustrated in FIG. 3 may be performed in a variety of systems, including systems such as systems 100 and 200, described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

An application customizer 102 enables a feature to be selected 302, through an interface, for an experiment rollout to an audience. A feature performance optimizer 108 receives 304 an audience segment based on the selected audience. The feature performance optimizer 108 determines 306 business goals for the experiment based on defined key performance indicators (KPIs). Such business goals may include monetization, engagement, usage, acquisition, etc. KPIs may include thresholds that are defined by business users, such as administrators of the feature optimization system 100.

User devices 120 that are included in the audience segment receive 308 the feature deployed in a version of the application. A performance tracker 106 receives 310 user actions associated with the feature as events emitted from the application operating on the user devices 120. This event data is communicated to the feature performance optimizer 108. A performance indicator of the feature is generated 312 against the business goals. The performance indicator may include measurable data, such as minutes viewing content, conversion rates for paid subscriptions on the application, and so forth.

The feature performance optimizer 108 may then optimize 314, increase or decrease rollout to a percentage of user devices in the audience segment, based on the performance indicator. This either increases or decreases the rollout, or pushed configuration of the selected feature, to user devices 120 in step 308. This may loop until the performance indicator meets or exceeds a threshold for success, the entire target audience of user devices in the targeted segment is covered, or the rollout is reduced to zero.

The feature performance optimizer 108 then optimizes 316 across the active experiment rollouts per audience segment based on the associated performance indicators. Balancing multiple KPIs for the active experiment rollouts per audience segment may be accomplished automatically using machine learning and/or artificial intelligence techniques, in an embodiment.

The application customizer 102 receives 318 one or more predicted successful experiment rollouts of features to the selected audience based on similar segments in other regions. These recommendations, provided by a predictive feature selector 110, uses the tracked performance data of the experiments as captured by the performance tracker 106 stored in the KPI data store 220.

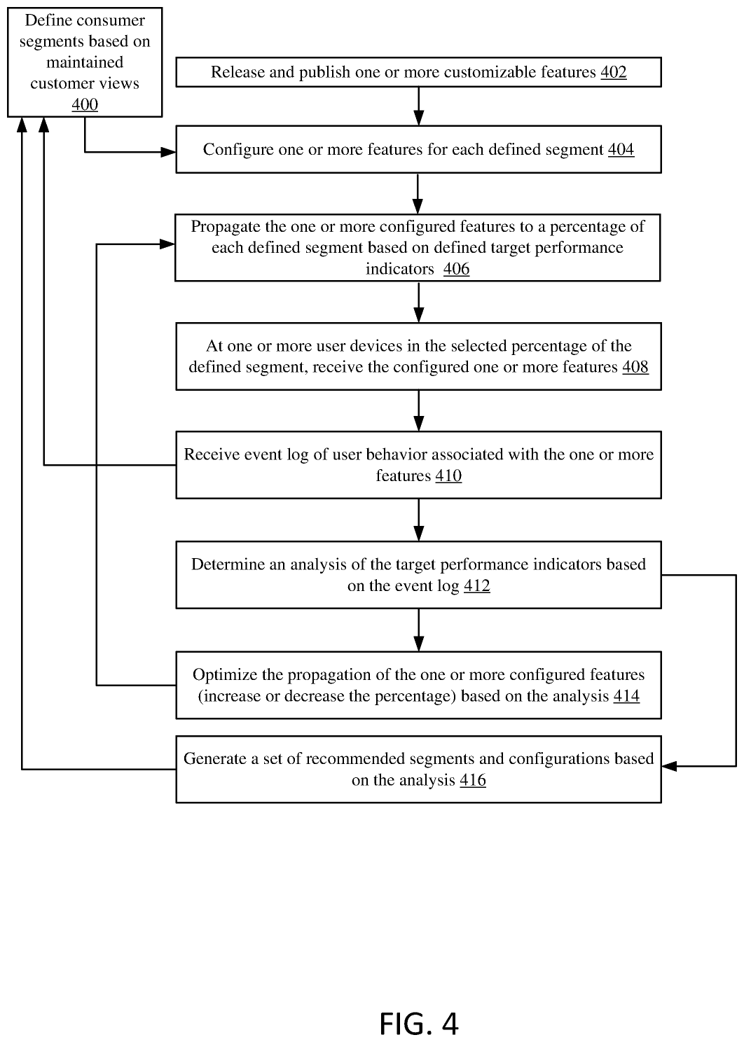

FIG. 4 illustrates an example flow for optimizing features deployed to a percentage of targeted segments, according to an embodiment. The various elements of flow 400 may be performed in a variety of systems, including systems such as systems 100 and 200, described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

Block 400 comprises defining consumer segments based on maintained customer views. This includes ingesting event data captured by the performance tracker 106 as well as other application log data used to generate user profiles for the users of the adaptive application.

Block 402 comprises an adaptive application releasing and publishing one or more customizable features. This includes a listing of the customizable features, including flows and/or journeys, that are configurable by the optimization system 100.

Block 404 comprises configuring one or more features for each defined segment.

Block 406 comprises propagating the one or more configured features to a percentage of each defined segment based on defined target performance indicators.

Block 408 comprises, at one or more user devices in the selected percentage of the defined segment, receiving the configured one or more features.

Block 410 comprises receiving an event log of user behavior associated with the one or more features. After block 410, the customer views, or user profile, may continue to be maintained as new consumer segments are defined 400.

Block 412 comprises determining an analysis of the target performance indicators based on the event log. This may be performed after block 410, in an embodiment. After block 412, block 414 or block 416 may be performed, based on the analysis.

Block 414 comprises optimizing the propagation of the one or more configured features based on the analysis. The optimizing includes increasing or decreasing the percentage of the user devices included in the defined segment. This leads to block 406, in an embodiment, forming a loop, until the analysis of the target performance indicators in block 412 indicates that the feature is fully optimized.

Block 416 comprises generating a set of recommended segments and configurations based on the analysis. This may occur after determining that a feature is fully optimized based on the analysis. After block 416, the customer views, or user profile, may continue to be maintained as new consumer segments are defined 400.

### 4.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

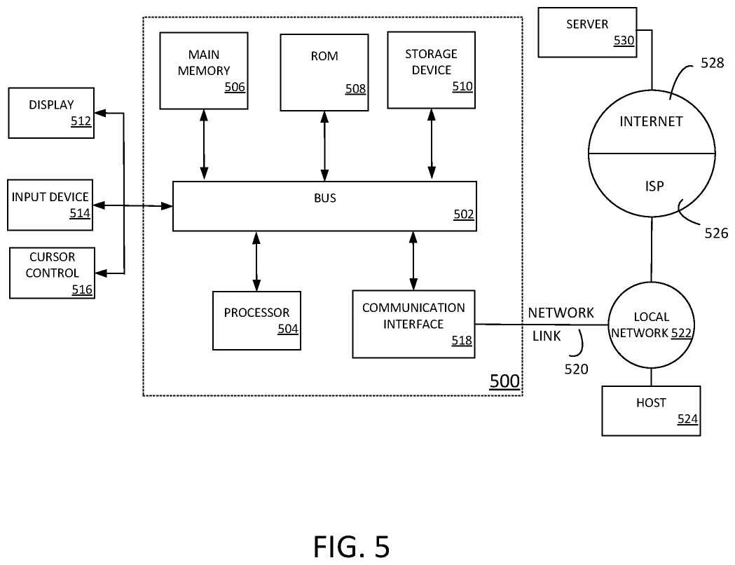

FIG. 5 is a block diagram that illustrates a computer system 500 utilized in implementing the above-described techniques, according to an embodiment. Computer system 500 may be, for example, a desktop computing device, laptop computing device, tablet, smartphone, server appliance, computing mainframe, multimedia device, handheld device, networking apparatus, or any other suitable device.

Computer system 500 includes one or more busses 502 or other communication mechanism for communicating information, and one or more hardware processors 504 coupled with busses 502 for processing information. Hardware processors 504 may be, for example, a general purpose microprocessor. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes a main memory 506, such as a random access memory (RAM) or other dynamic or volatile storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, is provided and coupled to bus 502 for storing information and instructions.

Computer system 500 may be coupled via bus 502 to one or more displays 512 for presenting information to a computer user. For instance, computer system 500 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

In an embodiment, output to display 512 may be accelerated by one or more graphics processing unit (GPUs) in computer system 500. A GPU may be, for example, a highly parallelized, multi-core floating point processing unit highly optimized to perform computing operations related to the display of graphics data, 3D data, and/or multimedia. In addition to computing image and/or video data directly for output to display 512, a GPU may also be used to render imagery or other video data off-screen, and read that data back into a program for off-screen image processing with very high performance. Various other computing tasks may be off-loaded from the processor 504 to the GPU.

One or more input devices 514 are coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

A computer system 500 may implement techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 506, from which processor 504 retrieves and executes the instructions. The instructions received by main memory 506 may optionally be stored on storage device 510 either before or after execution by processor 504.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as a 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send messages and receive data, including program code and/or other types of instructions, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

In an embodiment, some or all of the systems described herein may be or comprise server computer systems, including one or more computer systems 500 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 5.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving a listing of customizable features of an application;
generating a configuration of a feature included in the listing of customizable features, the configuration of the feature comprising a release associated with a targeted segment of users of the application, the release distributed to a percentage of the targeted segment of users;
communicating the configuration of the feature to a user device configured to execute the application;
receiving performance data associated with the feature from the user device;
determining metric data associated with a performance indicator associated with the feature using the performance data; and
optimizing distribution of the feature to other user devices included in the targeted segment of users of the application based on the metric data associated with the performance indicator.

2. The method of claim 1, further comprising generating user profiles based on the received performance data.

3. The method of claim 1, wherein optimizing distribution of the feature comprises increasing the percentage of the targeted segment of users.

4. The method of claim 1, wherein optimizing distribution of the feature comprises decreasing the percentage of the targeted segment of users.

5. The method of claim 1, further comprising generating a recommendation of the feature to another segment of users based on the metric data associated with the performance indicator.

6. The method of claim 5, further comprising selecting the recommendation of the feature to be associated with another release, the another release comprising the configuration of the feature, the another release distributed to the another segment of users.

7. The method of claim 1, wherein the distribution of the feature to other user devices is automatically optimized using one or more machine learning techniques.

8. One or more non-transitory computer-readable storage media, storing one or more sequences of instructions, which when executed by one or more processors cause performance of:
receiving a listing of customizable features of an application;
generating a configuration of a feature included in the listing of customizable features, the configuration of the feature comprising a release associated with a targeted segment of users of the application, the release distributed to a percentage of the targeted segment of users;
communicating the configuration of the feature to a user device configured to execute the application;
receiving performance data associated with the feature from the user device;
determining metric data associated with a performance indicator associated with the feature using the performance data; and
optimizing distribution of the feature to other user devices included in the targeted segment of users of the application based on the metric data associated with the performance indicator.

9. The one or more non-transitory computer-readable storage media of claim 8, the method further comprising generating user profiles based on the received performance data.

10. The one or more non-transitory computer-readable storage media of claim 8, wherein optimizing distribution of the feature comprises increasing the percentage of the targeted segment of users.

11. The one or more non-transitory computer-readable storage media of claim 8, wherein optimizing distribution of the feature comprises decreasing the percentage of the targeted segment of users.

12. The one or more non-transitory computer-readable storage media of claim 8, the method further comprising generating a recommendation of the feature to another segment of users based on the metric data associated with the performance indicator.

13. The one or more non-transitory computer-readable storage media of claim 12, the method further comprising selecting the recommendation of the feature to be associated with another release, the another release comprising the configuration of the feature, the another release distributed to the another segment of users.

14. The one or more non-transitory computer-readable storage media of claim 8, wherein the distribution of the feature to other user devices is automatically optimized using one or more machine learning techniques.

15. An apparatus, comprising:
a subsystem, implemented at least partially in hardware, that receives a listing of customizable features of an application;
a subsystem, implemented at least partially in hardware, that generates a configuration of a feature included in the listing of customizable features, the configuration of the feature comprising a release associated with a targeted segment of users of the application, the release distributed to a percentage of the targeted segment of users;
a subsystem, implemented at least partially in hardware, that communicates the configuration of the feature to a user device configured to execute the application;
a subsystem, implemented at least partially in hardware, that receives performance data associated with the feature from the user device;
a subsystem, implemented at least partially in hardware, that determines metric data associated with a performance indicator associated with the feature using the performance data;
a subsystem, implemented at least partially in hardware, that optimizes distribution of the feature to other user devices included in the targeted segment of users of the application based on the metric data associated with the performance indicator.

16. The apparatus as recited in claim 15, further comprising a subsystem, implemented at least partially in hardware, that generates user profiles based on the received performance data.

17. The apparatus as recited in claim 15, further comprising a subsystem, implemented at least partially in hardware, that generates a recommendation of the feature to another segment of users based on the metric data associated with the performance indicator.

18. The apparatus as recited in claim 17, further comprising a subsystem, implemented at least partially in hardware, that selects the recommendation of the feature to be associated with another release, the another release comprising the configuration of the feature, the another release distributed to the another segment of users.

19. The apparatus as recited in claim 15, wherein the distribution of the feature to other user devices is automatically optimized using one or more machine learning techniques.

20. The apparatus as recited in claim 15, further comprising a subsystem, implemented at least partially in hardware, that optimizes distribution of the feature based on multiple performance indicators associated with multiple releases associated with the targeted segment.
